(19) United States
(12) Patent Application Publication
(10) Pub. No.: US 2015/0015885 A1
(43) Pub. Date: Jan. 15, 2015

(54) FLAME PHOTOMETRIC DETECTOR

(71) Applicant: Eric Garff, Tooele, UT (US)

(72) Inventor: Eric Garff, Tooele, UT (US)

(21) Appl. No.: 14/322,315

(22) Filed: Jul. 2, 2014

Related U.S. Application Data
(60) Provisional application No. 61/842,037, filed on Jul. 2, 2013.

(51) Int. Cl. G01N 21/72; G01N 30/74

(52) U.S. Cl. CPC G01N 21/72; G01N 30/74
USPC 356/417

(57) ABSTRACT

A flame photometric detector assembly can comprise an optics assembly including a focusing mirror adapted to provide a focal region, and a detector block associated with the focusing mirror. The detector block can include a body defining a sampling chamber, a combustion chamber positioned adjacent an outer periphery of the sampling chamber, and a sample column liner adapted to feed sample into the sampling chamber at the focal region.

This application claims the benefit of U.S. Provisional Patent Application No. 61/842,037, filed Jul. 2, 2013.

### BACKGROUND

Gas chromatography is used in analytical chemistry for various purposes, including analyzing compounds, identifying compounds, testing the purity of compounds, looking for the presence of compounds, separating compounds, etc. That being stated, there are many different gas chromatography technologies that are commonly used, including thermal conductivity detectors, flame ionization detectors, catalytic combustion detectors, discharge ionization detectors, dry electrolytic conductivity detectors, electron capture detectors, flame photometric detectors, and atomic emission detectors, to name a few. Flame photometric detectors (FPDs), in particular, use a photomultiplier tube (PMT) to detect spectral lines of compounds as they are burned within a combustion chamber within a FPD device. Thus, as burning compounds are eluted off the column, specific elements in the molecules are excited, e.g., phosphorus, sulfur, halogens, certain metals, etc., which emit electromagnetic energy of specific characteristic wavelength. The electromagnetic energy is then filtered and collected by the photomultiplier tube.

Though Flame photometric detectors are effective for collecting this electromagnetic energy information, the sensitivities of these devices can be improved. Thus, providing a flame photometric detector with improved sensitivity would be an advancement in the art.

### SUMMARY

A flame photometric detector assembly can comprise an optics assembly attached to a detector block. The optics assembly can include a focusing mirror adapted to provide a focal region. The detector block can be associated with the focusing mirror, and can include a detector body, a combustion chamber, and a sample column liner. The body can also include a sampling chamber positioned therethrough. The combustion chamber can be positioned adjacent an outer periphery of the opening. The sample column liner can be adapted to feed sample into the sampling chamber above the combustion chamber at the focal region.

In another example, a gas chromatography system can include the flame photometric detector assembly described above, a pre-concentrator for preparing sample for flame analysis, and a heating coil for ramping up the temperature of the sample as it is passed from the pre-concentrator device to the flame photometric detector.

In another example, a method of analyzing a fluid sample in a flame photometric detector assembly can comprise multiple steps. Steps can include establishing a focal region within a sampling chamber of a detector block, generating a flame within a combustion chamber such that the flame is extends beyond the combustion chamber and into the focal region, and introducing the fluid sample into contact with the flame such that initial contact between the fluid sample and the flame is within or immediately adjacent to the focal region and outside of the combustion chamber.

### BRIEF DESCRIPTION OF THE DRAWINGS

FIG. 1 gas chromatograph system including the flame photometric detector in accordance with examples of the present disclosure;

FIG. 2 is a side plan view of a flame photometric detector in accordance with examples of the present disclosure;

FIG. 3 is a front plan view of a detector block from a flame photometric detector in accordance with examples of the present disclosure;

FIG. 4 is a perspective view of the detector block of FIG. 3;

FIG. 5 is a side cutaway view of a flame photometric detector including a detector block and an optical assembly in accordance with examples of the present disclosure; and

FIG. 6 provides a larger detail of a portion of the flame photometric detector of FIG. 5.

It should be noted that the figures are not necessarily to scale and are merely exemplary of embodiments of the present invention and no limitations on the scope of the present disclosure are intended thereby.

### DETAILED DESCRIPTION

Although the following detailed description contains many specifics for the purpose of illustration, a person of ordinary skill in the art will appreciate that many variations and alterations to the following details are within the scope of the herein disclosed embodiments.

Before the present disclosure is described in greater detail, it is to be understood that this disclosure is not limited to particular embodiments described, as this may vary. It is also to be understood that the terminology used herein is for the purpose of describing particular embodiments only, and is not intended to be limiting, since the scope of the present disclosure will be limited only by the appended claims. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a sample” includes a plurality of samples.

The term “fluid” refers to any material in a liquid or gas (vapor) state that is mobile and can be used in the systems of the present disclosure. For example, the carrier fluid can be a carrier gas, and the sample fluid can be a vaporized sample fluid.

In this disclosure, “comprises,” “comprising,” “containing,” “having,” and the like can have the meaning ascribed to them in U.S. Patent law and can mean “includes,” “including,” and the like, and are generally interpreted to be open ended terms. The term “consisting of” is a closed term, and includes only the components, structures, steps, or the like specifically listed, and that which is in accordance with U.S. Patent law. “Consisting essentially of” or “consists essentially” or the like, when applied to compositions, structures or methods encompassed by the present disclosure refer to compositions, structures, or methods like those disclosed herein, but which may contain additional compositional components, structural groups, or method steps, etc. Such additional compositional components, structural groups, or method steps, etc., however, do not materially affect the basic and novel characteristic(s) of the compositions, structures, or methods, compared to those of the corresponding compositions, structures, or methods disclosed herein. In further detail, “consisting essentially of” or “consists essentially” or the like, when applied to compositions, structures, or methods encompassed by the present disclosure have the meaning ascribed in U.S. Patent law and the term is open-ended, allowing for the presence of more than that which is recited (e.g., trace contaminants, components not reactive with the polymer or components reacted to form the polymer, and the like) so long as basic or novel characteristics of that which is recited is not changed by the presence of more than that which is recited, but excludes prior art embodiments. When using an open ended term, like “comprising” or “including,” it is understood that direct support should be afforded also to “consisting essentially of” language as well as “consisting of” language as if stated explicitly.

It should be noted that sizes, ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range includes “about x to about y.” To illustrate, a size range of “about 1 mm to about 50 mm should be interpreted to include not only the explicitly recited concentration of about 2 mm to about 50 mm, but also include individual sizes (e.g., 1 mm, 20 mm, 40, mm, etc.) and any sub-ranges within the indicated range.

The term “about” as used herein, when referring to a numerical value or range, allows for a degree of variability in the value or range, for example, within 10%, or, in one aspect within 5%, of a stated value or of a stated limit of a range. It is understood that when the term “about” is used to describe a numerical range or value, that the flexibility of the term about is fully supported with respect to the range or value modified; however, the explicit range or value given is also fully supported as if the term “about” were removed.

In addition, where features or aspects of the disclosure are described in terms of a list or a Markush group, those skilled in the art will recognize that the disclosure is also thereby described in terms of any individual member or sub-group of members of the Markush group. For example, if X is described as selected from the group consisting of sulfur, phosphorus, halogens, and metals, claims for X being sulfur and claims for X being phosphorus are fully described as if listed individually. For example, where features or aspects of the disclosure are described in terms of such lists, those skilled in the art will recognize that the disclosure is also thereby described in terms of any combination of individual members or subgroups of members of list or Markush group. Thus, if X is described as selected from the group consisting of sulfur, phosphorus, halogens, and metals, and Y is described as selected from the group consisting of helium, hydrogen, and nitrogen, claims for X being phosphorus and Y being hydrogen are fully described and supported.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

With this in mind, the determination of the presence of sulfur or phosphorus, or other compounds (e.g., halogens, certain metals, etc.), can be carried out using flame photometric detectors. However, when looking for certain compounds in a sample at very low concentrations, improved device sensitivity can be beneficial. Furthermore, even with samples with more typical concentrations of compounds, improved sensitivity can be beneficial as it can lead to reduced time frames for running particular samples. Thus, in accordance with this or other advantages, the present disclosure is drawn to a flame photometric detector assembly that can comprise an optics assembly and a detector block. The optics assembly can include a focusing mirror adapted to provide a focal region. The detector block can be associated with the focusing mirror, and can include a detector body, a combustion chamber, and a sample column liner. The body can also include a sampling chamber therethrough. The combustion chamber can be positioned adjacent an outer periphery of the opening. The sample column liner can be adapted to feed sample into the sampling chamber and above the combustion chamber at the focal region.

In another example, a gas chromatography system can include the flame photometric detector assembly described above, a pre-concentrator device for preparing sample for flame analysis, and a heating coil for ramping up the temperature of the sample as it is passed from the pre-concentrator device, separation column, to the flame photometric detector.

In another example, a method of analyzing a fluid sample in a flame photometric detector assembly can comprise multiple steps. Steps can include establishing an optical focal region within a sampling chamber of a detector block, generating a flame within a combustion chamber such that the flame is extends beyond the combustion chamber and into the focal region, and introducing the fluid sample into contact with the flame such that the initial contact between the fluid sample and the flame is within or immediately adjacent to the focal region and outside of the combustion chamber. By “immediately adjacent,” what is meant is that the fluid sample is introduced so that the contact between the fluid sample and the flame initially occurs in close proximity such that the flame/fluid sample interaction undergo a majority of its interaction within the focal region, even if not initially contacted within the focal region. That being stated, in one example, the flame and the fluid sample can also contacted initially within the focal region.

In each of these examples, there are various features that are common to various embodiments. Thus, unless the context dictates otherwise, each example is applicable to all embodiments.

In each of these examples, it is noted that the optics assembly can also include a lens system positioned on an opposite side of the detector block with respect to the mirror, such that the lens system or assembly can collect the electromagnetic energy information provided by the flame and the focused reflection from the mirror. For example, the lens system or assembly can include lenses for focusing and collimating electromagnetic energy reflected from the focusing mirror through sample that has been contacted within or in close proximity (adjacent to) the flame extending above the combustion chamber. The optics assembly can also include a photomultiplier tube (PMT) sensing device that senses the electromagnetic energy after being focused and collimating by the lens system. Thus, the mirror can provide a focal region within the sampling chamber of the detector body, and the lens assembly can collect the electromagnetic energy appropriately for processing by the photomultiplier tube. Furthermore, the sample column liner can be positioned through the body and the combustion chamber and terminate beyond the combustion chamber at the focal region. Thus, the flame can be brought above an upper portion of the combustion chamber and into the focal region, and the sample can be introduced into contact with the flame at the focal region.

These and other arrangements will be clarified in terms of the accompanying FIGS., which provide various examples. However, these are merely examples, and other sizes and relationships of various components can be used, such as spacing of optics, curvatures of mirrors, size of detector blocks, sampling chamber sizes, combustion chamber sizes and location, etc. The drawings merely illustrate one possible arrangement in accordance with examples of the present disclosure.

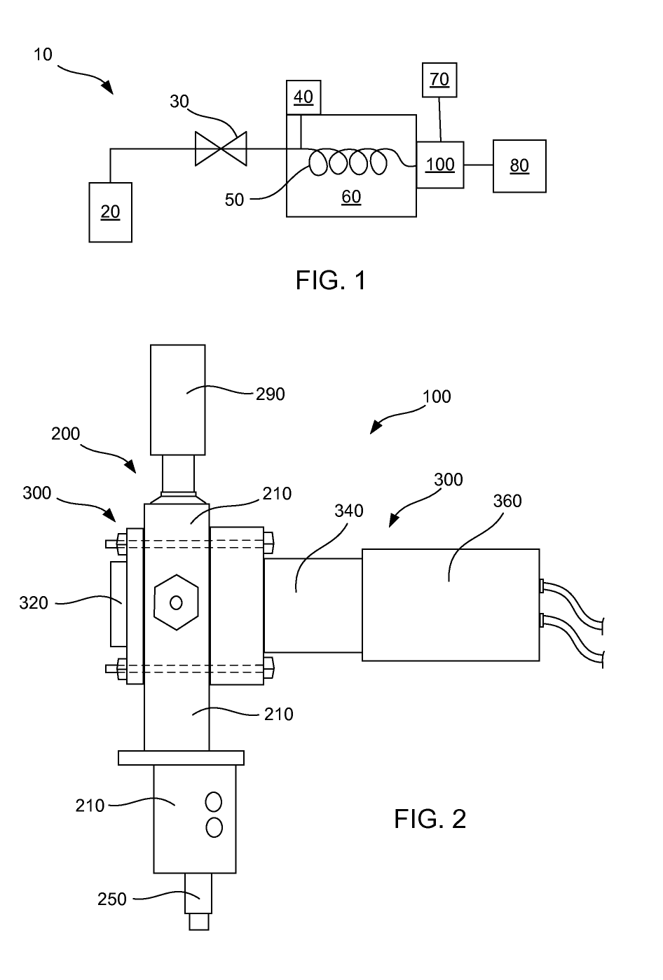

FIG. 1 depicts a gas chromatography system 10 or chromatograph. Essentially, a sample, supplied by a sample injector pre-concentrator tube 40, is carried through a flow-through narrow tube or sample column 50. In one example, the sample can be admixed with a carrier fluid 20 and the flow of the carrier fluid can be modulated using a flow controller 30. Suitable carrier fluids that may be used include helium, hydrogen, nitrogen, or other gases with low hydrocarbon, sulfur, and CO₂ impurities, etc. A column oven 60 can also be used to ramp up the temperature of the sample/carrier fluid within the coil, e.g., from 40° C. to 200° C., for example, though temperature profiles outside of this range can also be used, depending on the specific application. As the sample/carrier fluid leaves the sample column, it is introduced into the flame photometric detector 100, where flame analysis is conducted, as will be explained in greater detail hereinafter. Waste 70 is removed typically via a vent, which includes sample and combustion gases as introduction and flame analysis occurs. The data collected in by the flame photometric detector is provided to a data output module 80, which can be in the form of human or machine readable data. For example, the data can be in the form of printed tables, charts, numbers, graphs, etc., or can be in the form of digital or analog data suitable for use by a computer, tablet, network, etc.

With more specific reference to the flame photometric detector 100 per se, FIGS. 2-6 provide some additional details. In FIG. 2, a side view of an assembled flame photometric detector 100 is shown, which can include a detector block 200 and an optics assembly 300. The detector block can include a detector body 210, which is used to provide various structures and support for various attachments, as will be described in greater detail in subsequent FIGS. At the bottom of the body is a first combustion gas fitting 250 (other gas fittings not shown in this FIG.) and at the top of the body is a vent 290. The optics assembly, on the other hand, can include essentially three components: a focusing mirror 320, a lens assembly, and a photomultiplier tube (PMT). In this FIG., the lens assembly housing 340 and the PMT housing 360 are shown.

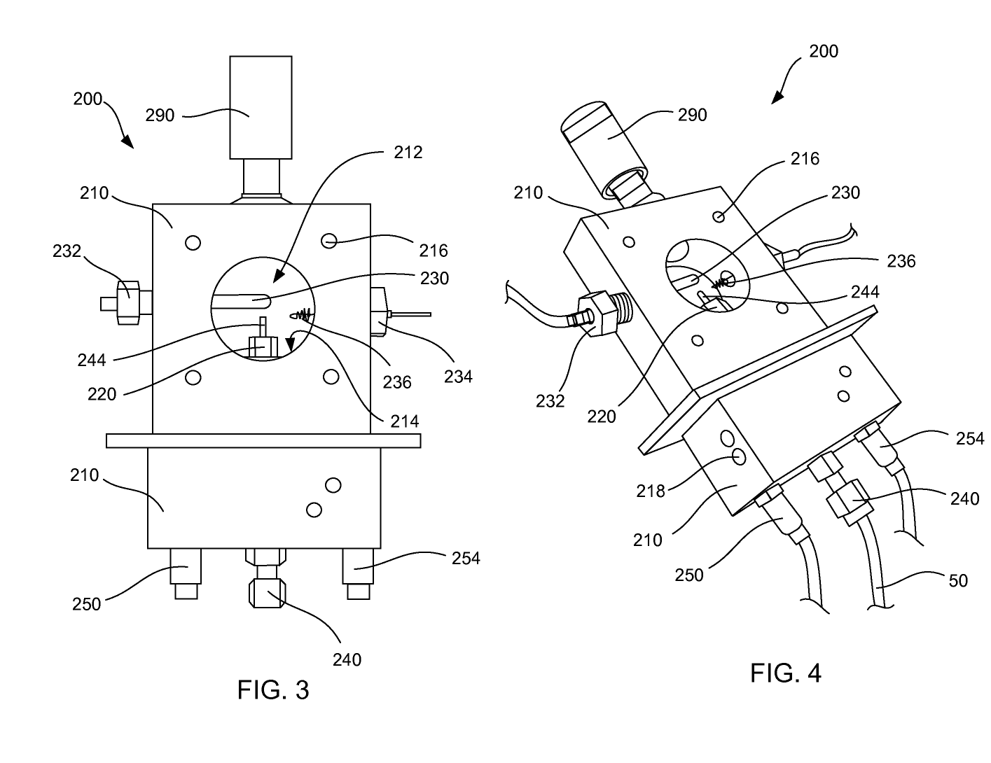

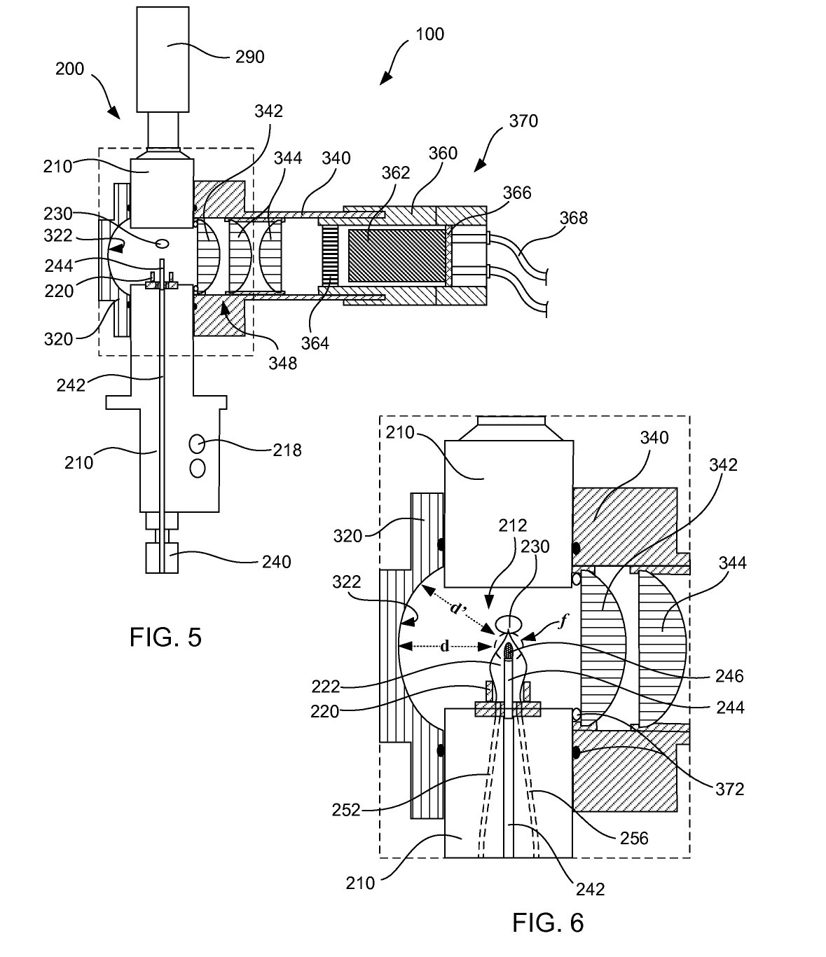

In further detail regarding the detector block 200, FIGS. 3 and 4 provide a front plan view and a perspective view, respectively, of the same. The detector block includes a body 210 and a vent 290 as previously described. Also shown are assembly openings 216 for attaching the optics assembly to the detector block. In operation, a sample, typically admixed with a carrier fluid, is introduced to the detector block from a column (50 in FIGS. 1 and 4). The column or some other intermediate flow device is attached to the detector block via the sample column fitting 240. A tube or column liner (not shown in FIGS. 3-4, but shown in detail in FIGS. 5-6) channels the sample through the detector block and into a sampling chamber 212 within the detector body. It is within this sampling chamber opening that the flame and sample are contacted for evaluation. The sampling chamber is also defined by an outer periphery 214 which also supports a combustion chamber 220 in this example.

The combustion chamber 220 is typically defined by a bottom surface and its side surfaces, but is open at a top region, thus allowing the flame to be exposed to the sampling chamber above the top region of the combustion chamber. It is noted, however, that the term “bottom” and “top” are relative to the combustion chamber, and do not necessarily infer orientation of the combustion chamber. Typically, the bottom surface is oriented downwardly and the top surface is oriented upwardly so that the flame has an upward trajectory. That being stated, one might contemplate an embodiment where the combustion chamber is on a side area of the outer periphery of the sampling chamber, and the flame exits the “top” of the combustion chamber in a sideways trajectory, and the focusing region would be positioned beyond where the flame exits the combustion chamber and enters the sampling chamber, as the flame curves upwardly. Thus, “top” and “bottom” are relative terms with respect to the direction of the flame “above,” or perhaps more appropriately, “beyond” the “top” opening of the combustion chamber.

Typically, in state of the art devices, the flame (not shown) is kept at a height at about the height of the combustion chamber, or even just slightly below or very slightly above the top of the combustion chamber. This does not bring the flame substantially into the region where the sensitivity of the optics can be maximized. Conversely, in accordance with examples of the present disclosure, the flame height can be well above the top of the combustion chamber, and can even by 1.5× or 2× the height of the combustion chamber. In one example, the flame can even be raised to a height where the flame contacts a flame thermocouple 230, and in some examples, the flame thermocouple may even act to suppress the flame height as the flame contacts the thermocouple. As the flame in examples of the present disclose can actually contact the flame thermocouple, the thermocouple can be recalibrated and configured to sense higher temperatures than typical in these types of devices because as modified, the present device may have the flame in direct contact with the flame thermocouple. A suitable temperature range under these conditions might be from 340° C. to 400° C., for example, as opposed to temperatures well below 300° C. in a more typical flame photometric detector where the flame stays within the combustion chamber. In the example shown, the flame thermocouple is attached to the body using a thermocouple fitting 232. Additionally, it is noted that the detector body can be warmed to an appropriate temperature using heating elements (not shown), such as by inserting them in the body heating cavities 218 shown specifically in FIG. 4.

Also unique to the present design is that related to the column liner (not shown within the detector body 210). In this example, the column liner is extended well above a top portion of the combustion chamber 220. More specifically, in this example, a column liner extension tube 244 is included to extend the column liner from at or about the bottom of the combustion chamber to well above the top of the combustion chamber. Thus, the sample is not introduced into the combustion chamber, but rather, is introduced above the combustion chamber well into the sampling chamber 212. By adding this column liner extension tube, the flame (now shown), which originates at the bottom of the combustion chamber, does not initially come into contact with the sample within the chamber, but rather, initially contacts the flame well above the combustion chamber in a central region of the sampling chamber. For this to occur, the flame, as described, is raised well beyond the top portion of the combustion chamber (See FIG. 6). Also, by initially contacting the flame and the sample outside of the combustion chamber, and corresponding that contact point to a focal region provided by the optics assembly (not shown in FIGS. 3-5, but shown in detail in FIGS. 5-6), increased sensitivity can be achieved.

Regarding the sensitivity increase, as an illustration, certain state of the art systems (e.g., without a curved mirror providing a focal region, and without bringing the sample into the chamber above the combustion chamber) that are currently used may not detect certain compounds at the Worker Population Limit (WPL) 0.000001 mg/m³ within required governmental guidelines, taking more than 15 minutes. Therefore, these standard systems also cannot detect such compounds at the General Population Limit (GPL) 0.0000006 mg/m³ within the governmental guidelines, again taking more than 15 minutes. The sample flame chamber and associated optics assembly of the present disclosure provide a sensitivity increase of greater than 25×, e.g., about up to 28×, when compared to some of these state of the art systems. With enhanced sensitivity, the flame photometric detectors of the present disclosure can be run at sensitivities that allow for faster run times, exceeding these governmental guidelines, e.g., providing run times of less than 15 minutes, and more specifically about 8 minutes. In further detail, where the comparative flame photometric detector may have a Method Detection Limit (MDL) 12,500 femtograms, the flame photometric detector of the present disclosure can be configured to have an MDL as low as 500 femtograms.

To use the system, the flame is ignited and maintained using various components. Specifically, a first combustion gas fitting 250 is used to attach a first gas source (not shown) to the detector body 210, and a second combustion gas fitting 254 is used to attach a second gas source (not shown) to the detector body. The gases that can be used include air, oxygen, hydrogen, or any other gas known for use in a gas chromatograph. The various gases are channeled to the combustion chamber 220, and the flow of gas allows for the flame to be ignited and maintained originating at the bottom of the combustion chamber. Once the gas is flowing, an igniter 236 coupled to the detector body with an igniter fitting 234, can be used to start the flame.

Turning now to FIGS. 5 and 6, a cross-sectional view of the flame photometric detector 100 and an enlarged view of a portion of the flame photometric detector are shown, respectively. Here, the detector block 200 includes a detector body 210, a sample column fitting 240 for attaching a sample column, and a vent 290 for removing combusted fluids and waste. Also shown in cross-sectional is a flame thermocouple 230. The sample, which can be carried by an inert carrier, is channeled from the sample column and into a sample column liner 242 that is typically within the detector body of the detector block. In this example, the sample column liner is extended from essentially a bottom portion of a combustion chamber 220, to an area beyond (and in this case, above) a top portion of the combustion chamber via a column liner extension tube 244. It is noted that the sample column liner can be a single integrated tube, or can be two tubes (including the sample column liner and the extension tube), as shown. In either scenario, the sample is not introduced into the combustion chamber, but rather, beyond the combustion chamber in the sampling chamber 212. Also shown specifically in FIG. 6 is a first combustion gas column liner 252 and a second combustion gas column liner 256, which are used for carrying the combustion gases into a bottom portion of the combustion chamber. These combustion gas liners are shown in phantom lines, as they would typically not be present along the same cross-sectional plane as the sample column liner. The combustion gases are used to ignite and maintain the flame 222 beyond or above the combustion chamber, and in one example, the flame can be suppressed by the flame thermocouple 230.

Turning now to a discussion of the optics assembly 300, there are essentially three major components shown in FIGS. 5 and 6. The assembly includes a focusing mirror 320, a lens assembly 348, and a photomultiplier tube assembly 370. The focusing mirror includes a reflective surface 322, which provides a focal region (f) within the sampling chamber 212 of the detector body 210. The focal region is essentially a location within the sampling chamber where concentrated electromagnetic energy from the flame 222 is reflected from the mirror back into the sampling chamber, along a trajectory distance (d). Since the reflective surface is curved, the electromagnetic energy reflection can be focused back to this area of concentrated energy. At this location of focused electromagnetic energy, the flame 222 first contacts the sample 246 outside of the combustion chamber 220. By contacting the sample 246 with the flame at the focusing region rather than within the combustion chamber (which is typical), a much greater sensitivity can be achieved. For example, the sensitivity of a flame photometric detector such as the one shown can be 10×, 20×, or even more that 25× greater than standard state of the art flame photometric detector that do not utilize a curved mirror with a focal region. Furthermore, the sensitivity of the exemplified device without the use of an extended column liner, where the flame is kept essentially within the combustion chamber and the sample is introduced at the bottom of the combustion chamber, does not perform as well with respect to sensitivity either (about 4× less sensitive). Thus, by both focusing electromagnetic energy at f and introducing the sample and flame together at f, both of these design details together provide a synergistic effect for significantly enhancing sensitivity, increasing throughput speed, etc. In certain examples, the focal region (f) can be from 5 mm to 20 mm from a midpoint of the focusing mirror, or alternatively, can be from 7 mm to 12 mm from a midpoint of the focusing mirror, or more specifically, from 8 mm to 10 mm from a midpoint of the focusing mirror. Other distances may be appropriate for other systems, but these distances work well for the system shown and described in the present FIGS.

As mentioned, the optics assembly 300 further includes a lens assembly 348 and a photomultiplier tube assembly 370. In this example, the lens assembly includes a focusing lens 342, such as a plano-convex lens, for collecting the electromagnetic energy from the sampling chamber 212, and a collimating lens system for providing suitable electromagnetic energy to be read by the photomultiplier tube 362 of the photomultiplier tube assembly. The lens assembly also includes a lens assembly housing 340 for supporting the various lenses, and for attaching the lens assembly to the detector body 210. In order to prevent electromagnetic energy or light from leaking into the sampling chamber of the detector body, TEFLON or rubber gaskets or O-rings 372 can be used to provide an appropriate seal. Also, the lens assembly housing (and the photomultiplier tube housing) can be made of a material that is opaque to external light, such as opaque TEFLON, e.g., black TEFLON. Likewise, the focusing mirror can also be equipped with similar gaskets or O-rings to prevent light leakage into the sampling chamber where the flame analysis is carried out.

Regarding the photomultiplier assembly 370, this portion of the optics assembly 300 can include the photomultiplier tube housing 360, which again should be opaque to external light, the photomultiplier tube 362, and an optical filter 364 for optically filtering the electromagnetic energy as appropriate for a particular sample or methodology. The photomultiplier tube can be mounted on a circuit board 366 which connects the photomultiplier tube to a pair of electrical leads or lines for outputting data collected by the photomultiplier tube and circuit board.

Regarding the control of various systems of the present disclosure, it is noted that generally, various modules can be used for various systems. For example, a heating module can be used to control the heating profile of the chromatograph system as a whole, or the flame photometric detector portion. In one example, the heating module can be used to control and/or measure the temperature of the pre-concentrator device, the heating coil or oven used to heat the sample column, the detector block, the flame thermocouple, etc. Other modules can also be used, such as flow control modules for controlling flow of sample and/or carrier fluids, or data output modules for collecting and reporting data to a user or a machine in the form of charts, graphs, numbers, computer readable information, etc.

In further detail regarding the function of the flame photometric detector 100, the chemiluminescent reactions of the sample as it contacts air or other gases is what can typically be used to collect and characterize the emitted electromagnetic energy. A flame 222, for example, fueled by hydrogen and air, can be used for detecting emitting species of sulfur, e.g., at 394 nm, or emitting species of phosphorus, e.g., at 510 nm to 536 nm. It can also be used for detecting emitting species of tin, boron, arsenic, chromium, etc., or other compounds of interest. Essentially, chemiluminescene of these or other compounds at specific wavelengths can be focused and collimated, giving an electromagnetic signal which can then be collected by the photomultiplier tube 362 and measured. To detect these emitting species, interference or other filters 364 can be used to isolate the emission bands of interest. Multiple filters can be selected for use, or in some examples, there are filters that may be suitable for multiple different emitting species.

While the invention has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. A flame photometric detector, comprising:
an optics assembly including a focusing mirror adapted to provide a focal region; and
a detector block associated with the focusing mirror, the detector block, including:
a detector body defining a sampling chamber,
a combustion chamber positioned adjacent an outer periphery of the sampling chamber, and
a sample column liner adapted to feed sample into the sampling chamber at the focal region.

2. The flame photometric detector of claim 1, wherein the focal region is from 5 mm to 20 mm from a midpoint of the focusing mirror.

3. The flame photometric detector of claim 1, wherein the focal region is from 7 mm to 12 mm from a midpoint of the focusing mirror.

4. The flame photometric detector of claim 1, wherein the optics assembly further comprises a lens system positioned on an opposite side of the detector block with respect to the focusing mirror.

5. The flame photometric detector of claim 4, wherein the lens system includes lenses for focusing and collimating electromagnetic energy reflected from the focusing mirror through sample at the focal region.

6. The flame photometric detector of claim 5, wherein the optics assembly further comprises a photomultiplier tube that senses the electromagnetic energy after being focused and collimating by the lens system.

7. The flame photometric detector of claim 1, wherein the sample column liner is positioned through the body and the combustion chamber and terminates beyond the combustion chamber at the focal region.

8. The flame photometric detector of claim 7, wherein the sample column liner comprises a column liner within the body, and a column liner extension tube extending the sample column liner from the column liner through and beyond the combustion chamber.

9. The flame photometric detector of claim 1, wherein detector body is adapted to be heated to a temperature suitable to substantially prevent condensation of the sample when flowing through the body.

10. The flame photometric detector of claim 1, wherein combustion chamber is positioned at a lower surface of the outer periphery.

11. The flame photometric detector of claim 10, wherein a top surface of the combustion chamber is outside of the focal region such that when combustion chamber includes a flame, the flame is extended above the combustion chamber to reach the focal region.

12. The flame photometric detector of claim 1, wherein the combustion chamber is adapted to sustain a flame beyond the combustion chamber and the sample column liner is adapted to dispense sample within or adjacent to the focal region, and wherein the detector block is adapted such that first contact between the sample and the flame occurs within the focal region.

13. The flame photometric detector of claim 1, wherein detector block further comprises an igniter.

14. The flame photometric detector of claim 1, wherein the detector block further comprises a flame thermocouple adapted to measure temperature.

15. The flame photometric detector of claim 14, wherein the flame thermocouple is positioned at or adjacent to the focal region such a flame from the combustion chamber is suppressed substantially at or beneath the thermocouple.

16. The flame photometric detector of claim 1, wherein the combustion chamber comprises one or more gas inlet openings for receiving a combustion gas or gases.

17. The flame photometric detector of claim 1, wherein the assembly is sealed using fitting seals and opaque housing assemblies to be devoid of external light leaks.

18. A gas chromatography system, comprising:
a pre-concentrator for preparing sample for flame analysis;
the flame photometric detector assembly of claim 1; and
a heating coil for ramping up the temperature of the sample as it is passed from the pre-concentrator to the flame photometric detector.

19. The gas chromatography system of claim 18, further comprising a heating module for controlling the temperature of the pre-concentrator device, the heating coil, and the detector block.

20. The gas chromatography system of claim 18, wherein the pre-concentrator is adapted to combine carrier fluid and fluid sample for analysis.

21. The gas chromatography system of claim 18, further comprising an output module for receiving information collected by the optics system and presenting it in the form of machine or human readable data.

22. A method of analyzing a fluid sample in a flame photometric detector, comprising:
establishing an optical focal region within a sampling chamber of a detector block;
generating a flame within a combustion chamber such that the flame is extends beyond the combustion chamber and into the focal region; and
introducing the fluid sample into contact with the flame such that the initial contact between the fluid sample and the flame is at the focal region and outside of the combustion chamber.

23. The method of claim 22, wherein the step of establishing the optical focal region is by the use of a curved mirror positioned adjacent to the detector block such that the focal region is within the sampling chamber of the detector block.

24. The method of claim 22, further comprising the step of optically sensing electromagnetic energy from the focal region.

25. The method of claim 24, wherein the step of optically sensing includes the use of an optics assembly including lenses for focusing and collimating the electromagnetic energy collected from the focal region where the flame contacts the fluid sample.

26. The method of claim 24, wherein the step of optically sensing includes the use of a photomultiplier tube.

27. The method of claim 22, wherein the flame extends beyond the combustion chamber at a height at least as great as the flame within the combustion chamber.

28. The method of claim 22, wherein the step of introducing the fluid sample into contact with the flame is by the use of a tube that is surrounded by the flame, and wherein the fluid sample cannot contact the flame until it is released at the focal region.

29. The method of claim 22, wherein the fluid sample and the flame initially contact one another within the focal region.

30. The method of claim 22, wherein the fluid sample and the flame initially contact one another immediately adjacent to the focal region.
